(19) United States
(12) Patent Application Publication
(10) Pub. No.: US 2015/0081653 A1
(43) Pub. Date: Mar. 19, 2015

(54) TYPE FREE SEARCH ASSIST

(71) Applicant: Yahoo! Inc., Sunnyvale, CA (US)

(72) Inventors: Kuo-Hsien Hsu, Taipei (TW); Yu-Chin Tai, Taipei (TW); Chien-Wen Chen, Taipei (TW)

(73) Assignee: Yahoo! Inc., Sunnyvale, CA (US)

(21) Appl. No.: 14/026,214

(22) Filed: Sep. 13, 2013

(51) Int. Cl. G06F 17/30; G06F 3/0488

(52) U.S. Cl. CPC G06F 17/30864; G06F 3/04883; G06F 2203/04808
USPC 707/706

(57) ABSTRACT

Techniques are described herein for assisting a user of a portable computing device with a touch screen display in formulating a search engine search query. The techniques may assist the user in a more efficient funnel querying approach when compared to conventional funnel querying approaches. In particular, with the techniques, the user can add one or more additional keywords to an initial search query without having to enter the individual letters of the additional keywords. As a result, the techniques enable the user to find relevant search results with less tedium and frustration compared to conventional funnel querying approaches, thereby increasing user satisfaction with the search engine.

### FIELD OF THE INVENTION

The present invention relates generally to assisting users of portable computing devices with touch screen displays in formulating search engine search queries comprising search query keywords and, in particular, to techniques for assisting the users in formulating the search queries without having to enter the individual letters of the keywords.

### BACKGROUND

Search engine users often perform multiple searches before they find a search result of interest. Sometimes users will adopt a “funnel” approach in which an initial search query of one or a small number of keywords is submitted to the search engine in the hope that the search result page returned by the search engine in response to the query will contain a relevant search result. If the returned page does contain a relevant search result, then then the user has found a relevant search result without having to enter more keywords than were necessary to find a relevant search result. If the returned page does not contain a relevant result, the user may then enter the individual letters of additional keywords to add to the initial query to produce a narrower query and then submit the narrower query to the search engine. Users of portable computing devices with touch screen displays may be especially inclined to use this approach because entering the letters of search query keywords using a soft keyboard can be tedious and frustrating.

As an example of the funnel querying approach, a user interested in purchasing a chromebook-type laptop computer may submit the following initial query to a search engine:

“chromebook”

If the user does not find a relevant result in the search result page returned in response to the initial query, the user may enter the letters of another keyword “samsung” and submit the following narrower query to the search engine:

“samsung chromebook”

If the user still does not find a relevant search result in the search result page returned in response to the narrower query, the user may enter the letters of yet another keyword “bestbuy” and submit the following even narrower query to the search engine:

“samsung chromebook bestbuy”

The user may find the task of entering the individual letters of the additional keywords “samsung” and “bestbuy” tedious and frustrating, especially if the user is using a portable computing device with a touch screen display where touch gestures on keys of a soft keyboard are used to enter the letters. As a result, the user may be dissatisfied with the search engine user experience.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

In the drawings in which like reference numerals refer to corresponding parts throughout the figures:

FIGS. 1A, 1B, 1C, and 1D illustrate exemplary user interfaces for assisting a user in formulating a search query on a portable computing device with a touch screen display in accordance with a first type free search assist technique.

FIGS. 2A, 2B, 2C illustrate exemplary user interfaces at various stages during performance of a progressive peek technique in accordance with some embodiments of the present invention.

FIGS. 3A and 3B illustrate exemplary user interfaces for assisting a user in formulating a search query on a portable computing device with a touch screen display in accordance with a second type free search assist technique.

FIG. 4 is a flowchart of a process for assisting a user in formulating a search query on a portable computing device with a touch screen display in accordance with some embodiments of the present invention.

FIG. 5 is a block diagram illustrating a portable computing device with a touch-sensitive display on which embodiments of the present invention may be implemented.

### DETAILED DESCRIPTION

### Overview

Techniques are described herein for assisting a user of a portable computing device with a touch screen display in formulating a search engine search query. The techniques may assist the user in a more efficient funnel querying approach when compared to conventional funnel querying approaches. In particular, with the techniques, the user can add one or more additional keywords to an initial search query without having to enter the individual letters of the additional keywords. As a result, the techniques enable the user to find relevant search results with less tedium and frustration compared to conventional funnel querying approaches, thereby increasing user satisfaction with the search engine.

In a first aspect, a method performed at a portable computing device is disclosed. The method includes detecting a first touch gesture on the touch screen display to select a search result summary of a search result document displayed on the touch screen display. For example, detecting the first touch gesture may include detecting a swipe or flick touch gesture across an area of the touch screen display where the search result summary is displayed.

The method further includes displaying one or more selectable items in response to the detecting the first touch gesture. For example, each selectable item may be displayed as an actionable user interface element such as a hyperlink or a button.

Each selectable item may be associated with one or more suggested search query keywords. For example, four selectable items A, B, C, and D displayed in response to selecting a search result summary on a search result document for the initial search query “chromebook” may be associated with suggested keywords as follows:

A: “samsung” and “11.6”

B: “samsung”

C: “samung” and “amazon”

D: “11.6”

The one or more suggested keywords associated with a selectable item may be presented as part of the selectable item. For example, selectable items A, B, C, and D may be presented as four hyperlinks with the following respective hyperlink text:

A: samsung chromebook 11.6

B: samsung chromebook

C: samsung chromebook amazon

D: chromebook 11.6

The one or more suggested keywords associated with a selectable item may be determined by the search engine that provided the search result document to the portable computing device. The suggested keywords may be determined by the search engine based on the search result that is selected by the user. For example, the search engine may determine as the suggested keywords one or more keywords relevant to the search result. The relevant keywords may be determined by the search engine based on indexing data and/or query log data maintained by the search engine. For example, the search engine may determine the relevant keywords based on relevance metrics (e.g., TF-IDF) for index terms by which the search result is indexed by the search engine. As another example, the search engine may determine the relevant keywords based on query terms of historical queries for which the search result was a previous match. As yet another example, the search engine may determine the relevant keywords by combining index terms and historical query terms according to a term diversity metric such as, for example, an edit distance metric.

The method may further include determining a search query comprising the one or more suggested keywords associated with a particular selectable item of the one or more selectable items if a second touch gesture on the particular selectable item is detected, and sending the search query to a search engine. For example, detecting the second touch gesture may include detecting a tap or press touch gesture on the particular selectable item. The search query may be sent to a search engine that provided the search result document or the search query may be sent to another search engine. The search query may be sent to a search engine in response to detecting the second touch gesture or in response to detecting a third touch gesture such as, for example, a touch gesture to activate a search button presented on the search result document.

In a second aspect, a computer-program product is disclosed, comprising a non-transitory computer-readable medium and computer-executable instructions stored thereon. The instructions, when executed by a portable computing device with a touch screen display, may cause the device the device to perform the method of the first aspect.

In a third aspect, a portable computing device with a touch screen display is disclosed. The device comprises a type free search assist mechanism. The type-free search assist mechanism is configured to perform the method of the first aspect.

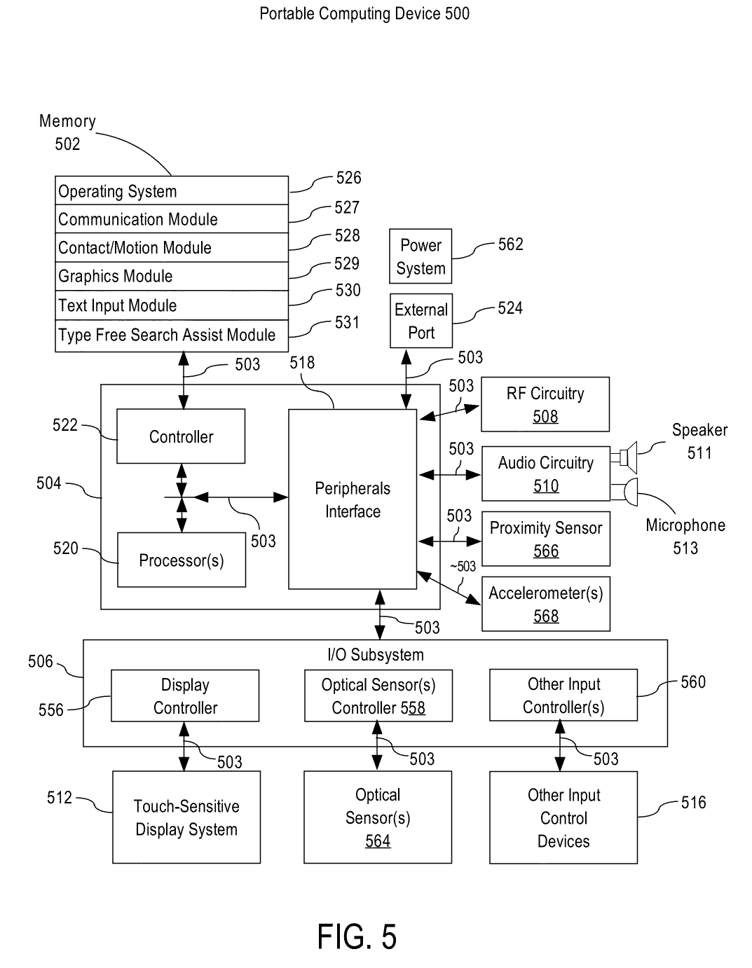

Attention is now directed towards embodiments of user interfaces (“UI”) and associated techniques and processes that may be implemented on a portable computing device with a touch screen display. An example portable computing device suitable for implementing the user interfaces, techniques, and processes is described below with respect to FIG. 5. While embodiments described herein may be implemented on a portable computing device with a touch screen display, the embodiments may be implemented on other types of computing devices including non-portable computing devices. For example, the embodiments may be implemented on a desktop computing device with or operatively coupled to a touch sensitive surface. The touch sensitive surface can overlay a display screen to form a touch screen display or be separate from the display screen. For example, the touch sensitive surface can be a touch pad.

### A First Type Free Search Assist Technique

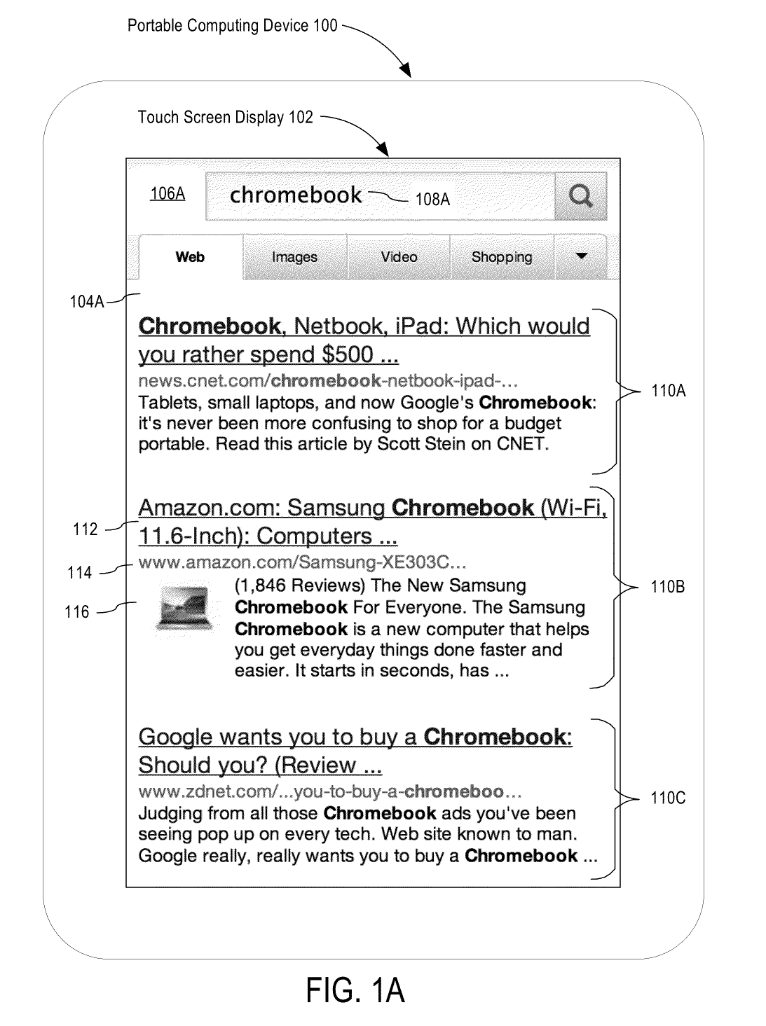

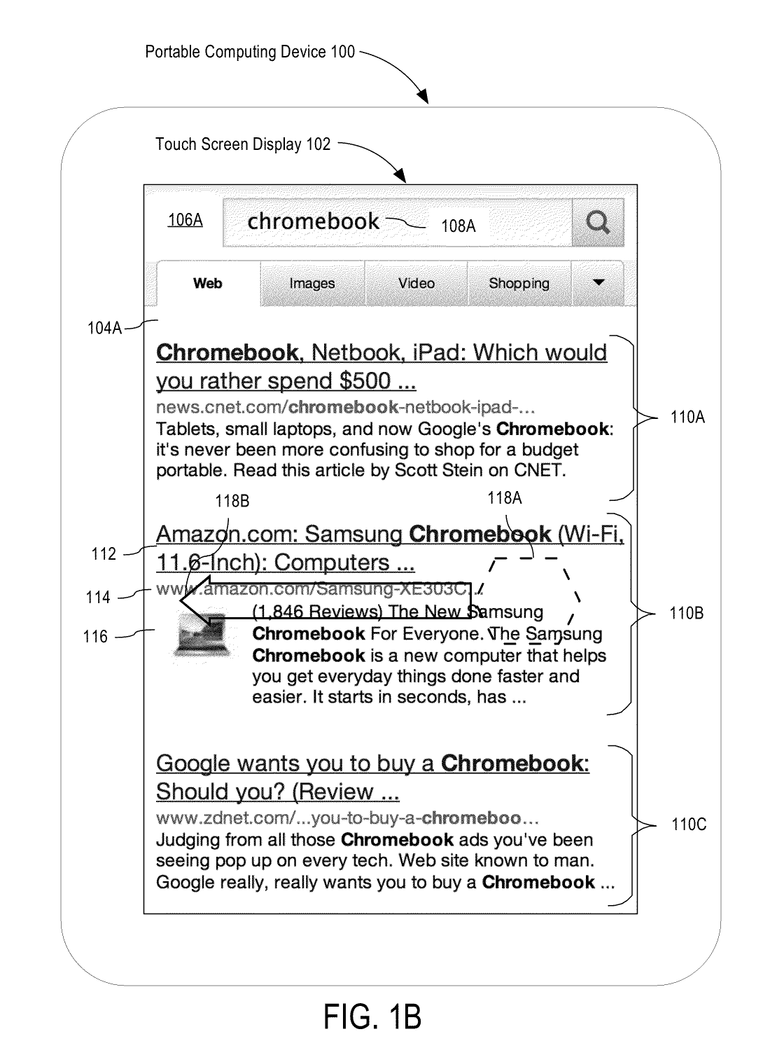

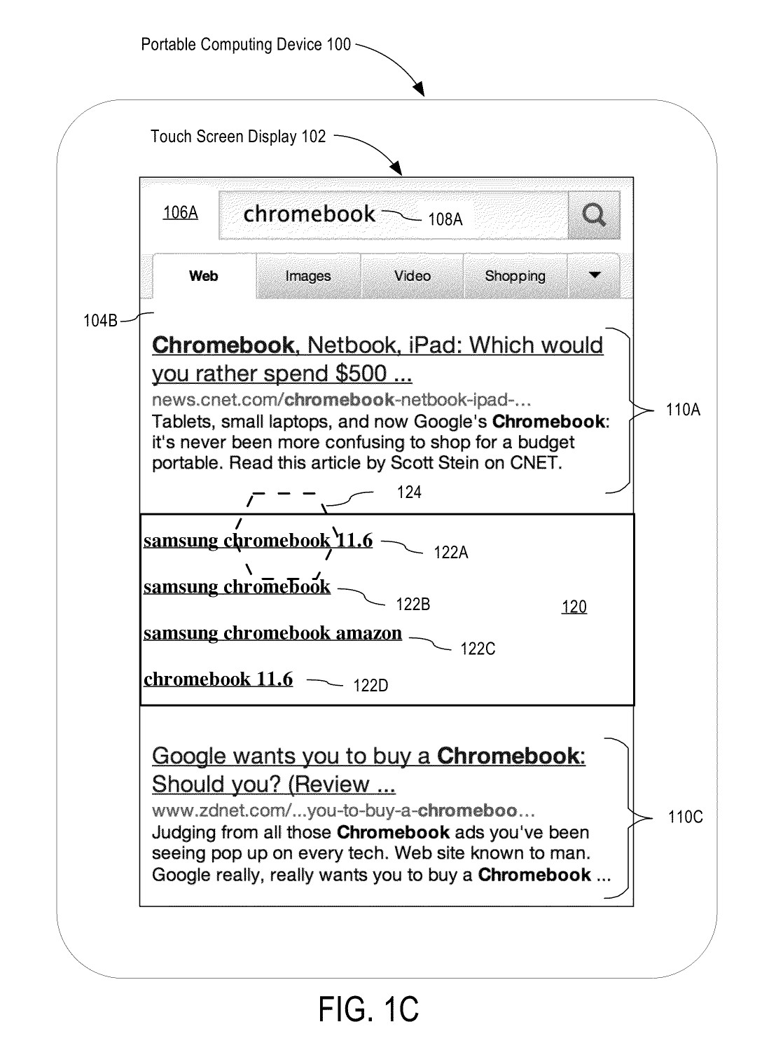

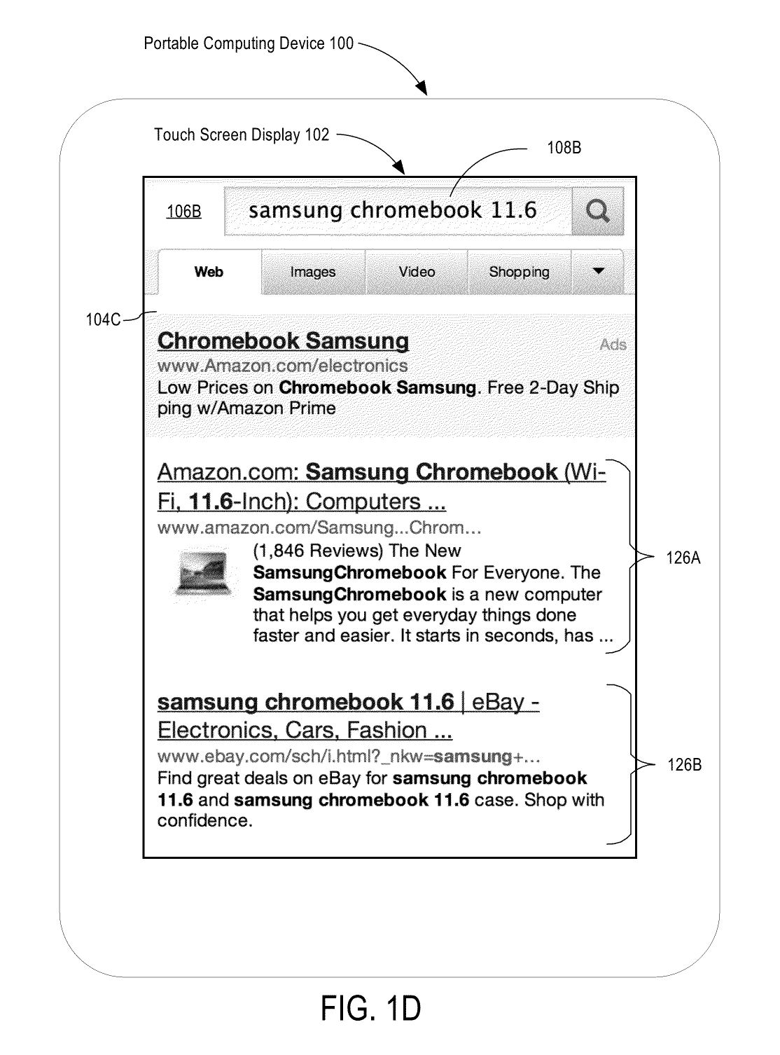

FIGS. 1A, 1B, 1C, and 1D illustrate exemplary user interfaces for assisting a user in formulating a search query on a portable computing device 100 with a touch screen display 102 in accordance with a first type free search assist technique. The portable computing device 100 includes, but is not necessarily limited to, virtually any human carry-able computing device with a touch screen display such as, for example, a smartphone, a laptop computer, a tablet computer, or other portable computing device with a touch screen display. Although shown in the figures as part of the form factor of portable computing device 100, the touch screen display 102 may instead be a separate device operatively coupled to the portable computing device 100 by a wired (e.g., an electrical cable) or wireless (e.g., a high-frequency radio link) communication link.

Users of search engines may have an incomplete information need. For example, a user may be interested in purchasing a chromebook laptop computer but may not know particular manufacturers that make chromebook computers or particular websites that sell chromebook computers. As a result of having only an incomplete information need, the initial query that user submits to the search engine may also be incomplete. For example, the user interested in purchasing a chromebook laptop computer may submit the search query “chromebook” to a search engine.

Even if the user's information need is complete, the user may still submit an incomplete initial search query. For example, a user that knows she wants to purchase a samsung chromebook with an 11.6″ inch screen from Amazon.com may still submit the initial search query “chromebook” to a search engine. For example, the user may not want to type the individual letters of “amazon”, “11.6”, or “samsung” when formulating the initial search query, especially if the user must enter the individual letters on a soft keyboard presented on a touch screen display.

According to the first type free search assist technique, a user that submits an initial search query to a search engine is assisted in formulating another search query without having the enter the individual letters of search query keywords. The first technique involves suggesting search query keywords to the user based on a selected search result summary returned in response to the initial query. The user can view the search result summaries returned in response to the initial query for a search result summary that appears relevant to the user's information need. If the user identifies a relevant search result summary, the user can perform a touch gesture directed to the area of the touch screen display where the search result summary is displayed. In response to the touch gesture, the user is provided one or more selectable suggested search queries generated based on the search result of the selected search result summary. The user can select one of the suggested search queries for submission to a search engine without having to type individual letters of search query keywords. The first type free search assist technique will now be explained by an example with reference to the figures.

Turning first to FIG. 1A, it shows UI 104A displayed on touch screen display 102 of device 100. In this example, UI 104A contains a web page document 106A served by a search engine. In particular, the web page document 106A is a search result document returned by the search engine in response to receiving and processing the search query 108A “chromebook”.

For purposes of this description, the term “search query” includes, but is not necessarily limited to, virtually any sequence of printable characters (e.g., printable ASCII or printable UNICODE characters) submitted to a search engine representing a user's information need. A search query may include one or more search query keywords.

As used herein, the term “search query keyword” or just “keyword” includes, but is not necessarily limited to, virtually any sequence of printable non-whitespace characters used in a search query.

For purposes of providing clear examples, example search queries and search query keywords in this description are enclosed in double quotes (“ ”). The example search queries and search query keywords in this description are intended to represent both (a) forms where the enclosing double quotes are part of the example search queries and search query keywords, and (b) forms where the enclosing double quotes are not part of the examples. For example, the search query “samsung chromebook amazon” is intended to represent both the search query samsung chromebook amazon (without enclosing double quotes) and the search query “samsung chromebook amazon” (with enclosing double quotes).

As used herein, the term “search result document” includes, but is not necessarily limited to, virtually any document that includes one or more search results and/or one or more search result summaries returned or served by a search engine in response to processing a search query. For example, search result document 106A includes search result summaries 110A, 110B, and 110C returned by a search engine in response to processing the search query 108A “chromebook”.

A search result document may contain one or more search result summaries that summarize search results of a search query. As used herein, the term “search result” includes, but is not necessarily limited to, information identified by a search engine as relevant to a search query. The information may be text (e.g., a web page document), an image, audio, video, and/or an animation, as just some examples. As used herein, the term “search result summary” includes, but is not necessarily limited to, information that summarizes a search result identified by a search engine as relevant to a search query. For example, search result document 106A contains three search result summaries 110A, 110B, and 110C summarizing search results of the search query “chromebook”.

A search result summary can take a variety of different forms and embodiments are not limited to any particular search result summary form. For example, search result summaries 110A, 110B, and 110C are in title-abstract-URL (TAU) form. For example, search result summary 110B includes a title 112 (which is also an actionable hyperlink to the search result), a uniform resource locator (URL) 114 of the search result, and a text abstract 116 of the search result.

In the example UI 104A, search result summaries 110 summarize web page search results. However, search result summaries may summarize other types of search results and may take other forms more appropriate for the particular type of search results at hand. For example, a search result summary of a digital image search result may include a thumbnail image or reduced resolution image of the image. As another example, a search result summary of a video may include a preview image comprising a selected frame of the video, an animated image comprising selected frames of the video, a preview portion of the video, or highlights of the video. Thus, search result summaries within the scope of the invention are not limited to the TAU form or any other particular form and may take virtually any form suitable for summarizing different types of search results according to the requirements of the particular implementation at hand.

Turning now to FIG. 1B, it depicts a touch gesture 118 performed in an area of the touch screen display 102 to select search result summary 110B. In this example, the touch gesture 118 is a right-to-left drag, swipe or flick touch gesture starting at contact point 118A and proceeding to contact point 118B while contact is maintained with the touch screen display 102. However, the touch gesture 118 could just as easily another type of touch gesture. For example, touch gesture 118 could be a left-to-right drag, swipe, or flick touch gesture starting at contact point 118B and proceeding to contact point 118A while contact is maintained with touch screen display 102. As another example, touch gesture 118 could be a press, tap, or double-tap touch gesture instead of a drag, swipe, or flick touch gesture. Contact with the touch screen display 102 may be made with a finger or a stylus, for example.

While in some embodiments touch gestures are performed by a user to a select search result summary and to perform other actions described herein, other user actions are performed in other embodiments to provide user input. For example, instead of detecting touch gestures, user input can be detected by tracking user movement using a camera or other optical sensor of the portable computing device. As another example, user input can be detected by tracking user eyeball movement using a camera or other optical sensor of the portable computing device. For example, the portable computing device can be a wearable headset with an optical head-mounted display.

As used herein, a “drag” or “swipe” touch gesture includes, but is not necessarily limited to, one where the user moves a touch over the surface of the touch screen from a first point of contact to a second point of contact without losing contact with the touch screen during the movement and then releases contact with the touch screen at the second point of contact. For example, the user may perform a drag or swipe gesture by moving a fingertip over the touch screen surface without losing contact.

As used herein, a “flick” touch gesture includes, but is not necessarily limited to, one where the user quickly brushes the surface of the touch screen. For example, the user may perform a flick gesture by quickly brushing the touch screen surface with a single finger.

A “tap” touch gesture includes, but is not necessarily limited to, one where the user briefly touches the surface of the touch screen at a single point of contact. For example, the user may perform a tap gesture by briefly touching the touch screen surface with a fingertip.

A “press” touch gesture includes, but is not necessarily limited to, one where the user touches the surface of the touch screen at a single point of contact for an extended period of time (e.g., more than one second). For example, the user may perform a press gesture by touching the touch screen surface with a single finger for an extended period of time such as more than one second.

A “double tap” touch gesture includes, but is not necessarily limited to, one where the user rapidly touches the surface of the touch screen twice at the same or approximately same point of contact. For example, the user may perform a double tap gesture by rapidly touching the touch screen surface twice with a fingertip.

As a result of touch gesture 118, UI 104B of FIG. 1C is displayed on touch screen display 102. UI 104B includes a selectable item panel 120 that visually overlays the selected search result summary 110B. The panel 120 includes four selectable items 122A, 122B, 122C, and 122D. In this example, each selectable item 122 is an actionable hyperlink which, if activated, causes a corresponding suggested search query to be submitted to the search engine that provided the search result summaries 110 in response to the initial search query 108A “chromebook”.

Each selectable item 122 indicates that the suggested search query that would be submitted if selected. For example, selectable item 122A indicates that the suggested search query “samsung chromebook 11.6” would be submitted to the search engine if selected.

Each suggested search query includes one or more search query keywords determined based on the search result of the selected search result summary 110B. In particular, the suggested search query associated with selectable item 122A includes the determined search query keywords “samsung” and “11.6”, the suggested search query associated with selectable item 122B includes the determined search query keyword “samsung”, the suggested search query associated with selectable item 122C includes the determined search query keywords “samsung” and “amazon”, and the suggested search query associated with selectable item 122D includes the determined search query keyword “11.6”. In addition, all of the suggested search queries include the initial search query 108A “chromebook”. Thus, all of the suggested search queries are narrower than the initial search query 108A “chromebook”.

While in some embodiments as exemplified in FIG. 1C, the graphical user interface panel 120 presenting the selectable items 122 visually overlays and obscures the search result summary 110B that was selected, the panel 120 does not overlay and visually obscure the selected summary in other embodiments. For example, the panel 120 may overlay all or a part of the selected summary 110B with a degree of transparency so that the underlying summary 110B is still at least partially visible through the panel 120. As another example, the panel 120 may be displayed such that no part of the content of the summary 110B is overlaid or obscured.

While in the embodiment of FIG. 1C, selectable items 122 are displayed as actionable hyperlinks, selectable items 122 may be displayed as other actionable user interface elements in other embodiments. For example, selectable items 122 may be displayed as actionable buttons or actionable icons. An actionable user interface element includes, but is not necessarily limited to, one that causes an action to be performed such as, for example, a search query being sent to a search engine, in response to user input being directed to the user interface element.

Also as shown in FIG. 1C, touch gesture 124 is performed to select selectable item 122A. In this example, touch gesture 124 is a tap, a press, or double tap touch gesture, but could just as easily be another type of touch gesture.

In response to touch gesture 124, the search query “samsung chromebook 11.6” is submitted to the search engine that provided the search results summaries 110 of search result document 106A.

Also in response to touch gesture 124, as shown in UI 104C of FIG. 1D, search result document 106B including search result summaries 126A and 126B are displayed on touch screen display 102. Note, with the first type free search assist technique, the user was able to obtain search result document 106B containing search result summaries 126A and 126B without having to enter individual letters of the search query keywords “samsung” and “11.6”.

### Progressive Search Result Peeking

In the example UI 104B of FIG. 1C, touch gesture 124 is performed to select selectable item 122A. Instead of selecting a selectable item, the user may repeat the touch gesture performed to select the search result summary to “peek” at the most relevant/highest ranked search result associated with the first selectable item displayed on the selectable item panel. The touch gesture may be repeated thereafter to peek at the most relevant/highest ranked search result associated with the next selectable item displayed on the selectable item panel, and so on. In this way, the user can progressively peek at the most relevant/highest ranked search result associated with each of the suggested search queries displayed on the selectable item panel.

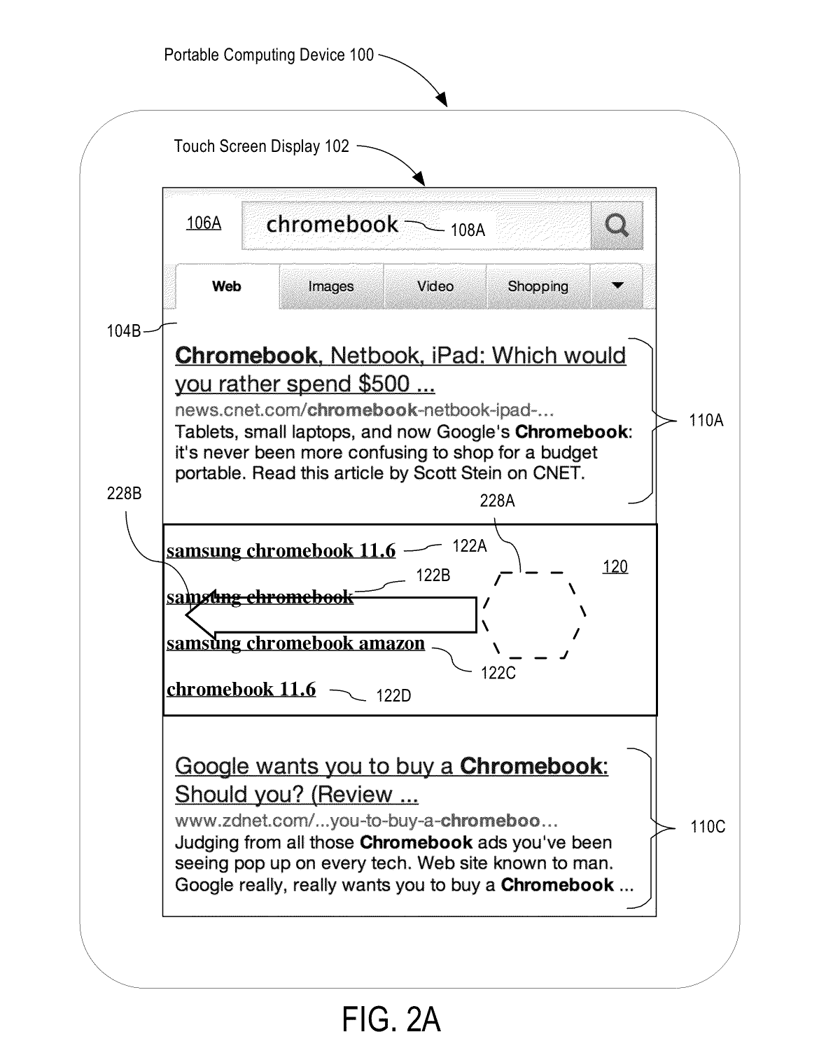

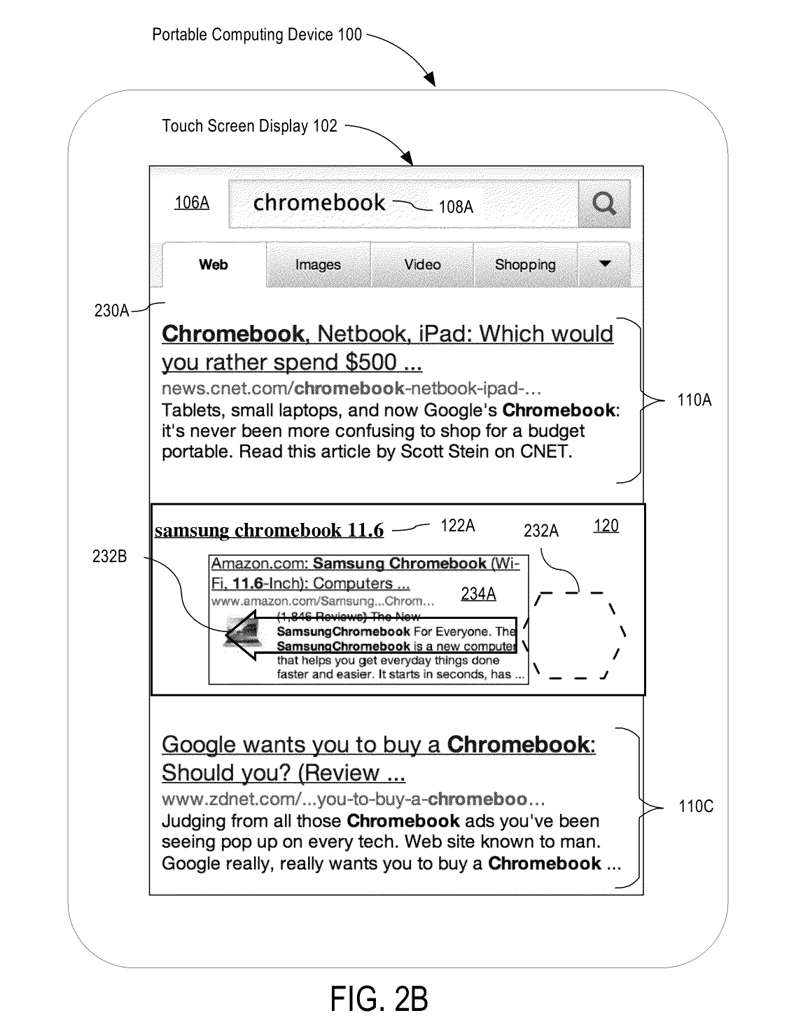

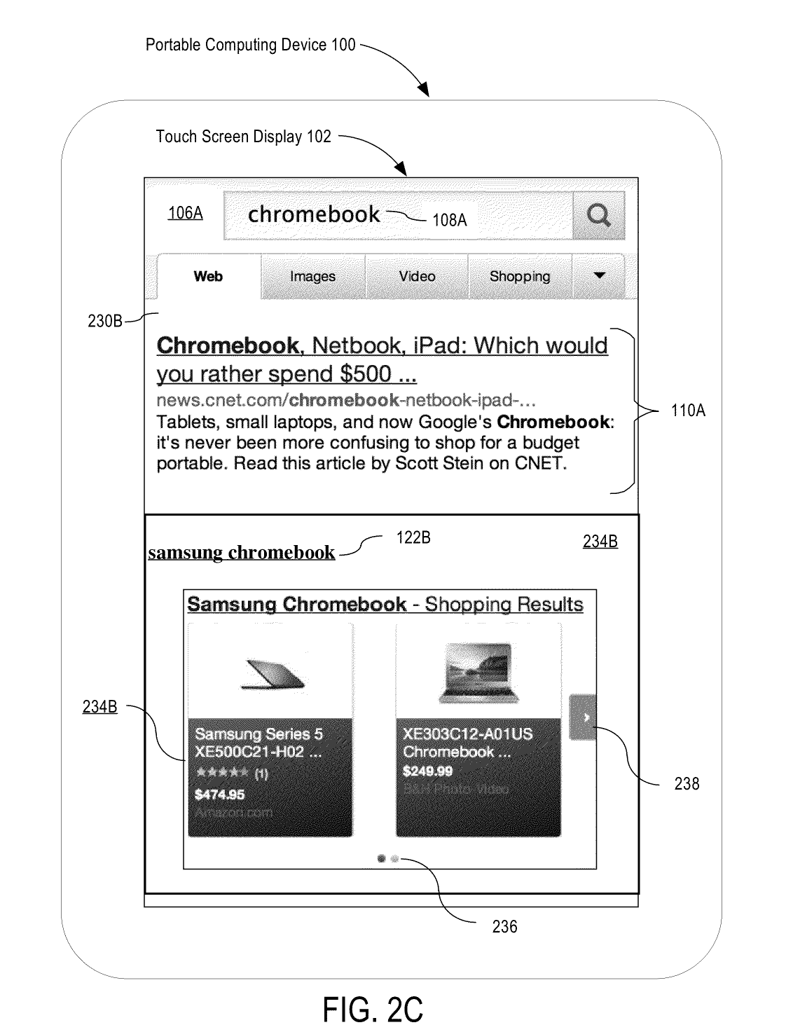

For example, UI 104B of FIG. 2A corresponds to UI 104B of FIG. 1C. However, instead of the user performing touch gesture 124 to select selectable item 122A, the user performs touch gesture 228 directed to panel 120. Touch gesture 228 is a drag, swipe, or flick touch gesture starting at contact point 228A and proceeding from right to left to contact point 228B while maintaining contact with touch screen display 102. However, touch gesture 228 could just as easily be another type of touch gesture. For example, touch gesture 228 could be a left to right drag, swipe, or flick gesture starting at contact point 228B and proceeding to contact point 228A.

In response to touch gesture 228, the first suggested search query “samsung chromebook 11.6” displayed on selectable item panel 120 and associated with selectable item 122A is submitted to the search engine. Also in response to touch gesture 228, UI 230A of FIG. 2B is displayed on touch screen display 102. UI 230A includes peek search result panel 234A displayed as an overlay to selectable item panel 120. Peek panel 234A contains a search result summary of the highest ranked/most relevant search result as determined by the search engine for the first search query “samsung chromebook 11.6” displayed on the selectable item panel 120. Thus, by performing touch gesture 228 as shown in FIG. 2A, the user can view a summary of the highest ranked/most relevant search result for the first suggested search query displayed on selectable item panel 120.

The user can then peek at the next suggested search query “samsung chromebook” displayed on selectable item panel 120 and associated with selectable item 122B by repeating the touch gesture used to peek at the first suggested search query. In particular, touch gesture 232 is another drag, swipe, or flick touch gesture. Touch gesture 232 starts at contact point 232A and proceeds from right to left to contact point 232B while maintaining contact with touch screen display 102. However, touch gesture 232 could just as easily be another type of touch gesture. For example, touch gesture 232 could be a left to right drag, swipe, or flick gesture starting at contact point 232B and proceeding to contact point 232A.

In response to touch gesture 232, the second suggested search query “samsung chromebook” displayed on selectable item panel 120 and associated with selectable item 122B is submitted to the search engine. Also in response to touch gesture 232, UI 230B of FIG. 2C is displayed on touch screen display 102. UI 230B includes peek search result panel 234B. Peek panel 234B contains a search result summary of the highest ranked/most relevant search result as determined by the search engine for the second suggested search query “samsung chromebook” displayed on the selectable item panel 120. Thus, by performing touch gesture 232 as shown in FIG. 2B, the user can view a summary of the highest ranked/most relevant search result for the second suggested search query displayed on selectable item panel 120.

In the example UI 230B of FIG. 2C, peek panel 234B is multi-part. A multi-part indicator 236 indicates that the peek panel 234B has two parts with the first part being currently shown. The user can view the second part by directing appropriate user input to next part button 238. Appropriate user input may be a tap, press, or double-tap gesture, for example.

The user may repeat the right-to-left drag, swipe, or flick touch gesture again to peek at the highest ranked/most relevant search result for the third suggested search query “samsung chromebook amazon” displayed on selectable item panel 120 and associated with selectable item 122C. After that, the user may again repeat the right-to-left drag, swipe, or flick touch gesture to peek at the highest ranked/most relevant search result for the fourth suggested search query “chromebook 11.6” displayed on selectable item panel 120 and associated with selectable item 122D.

As shown and described, the user is enabled to progressively peek at the highest ranked/most relevant search result for each suggested search query displayed on a selectable item panel that is displayed in response to selection of a search result summary.

### A Second Type Free Search Assist Technique

According to a second type free search assist technique, a user is enabled to select individual suggested search query keywords to add to a current search query displayed in a search query field. With the technique, the user can add the additional search query keywords to the current search query without having to select individual letters of the additional keywords.

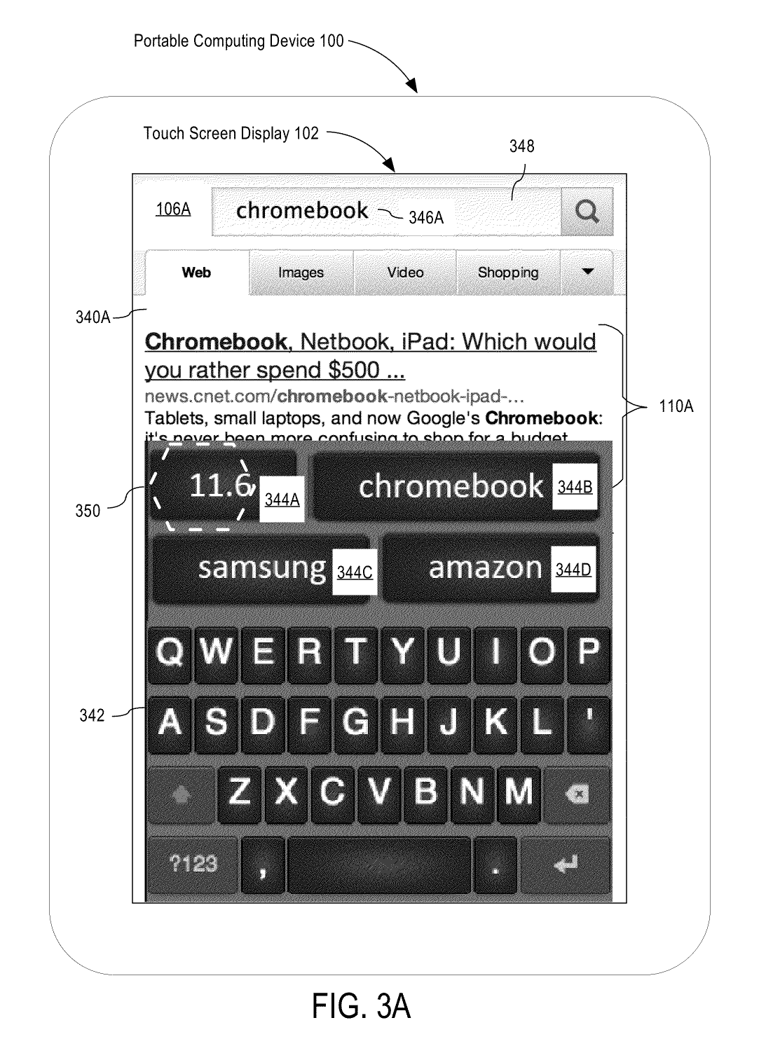

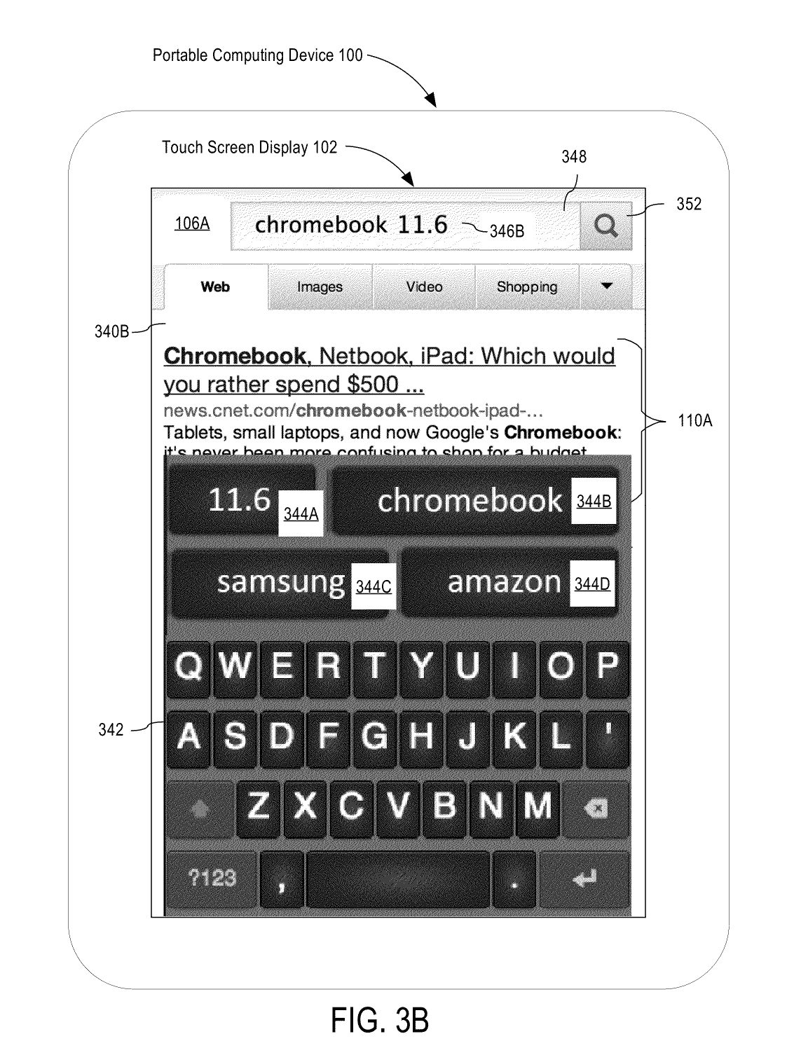

For example, in response to touch gesture 118 of FIG. 1B, UI 340A of FIG. 3A may be displayed instead of UI 104B of FIG. 1C. UI 340A includes keypad panel 342. Keypad panel 342 includes a virtual QWERTY keyboard and selectable items 344A, 344B, 344C, and 344D.

In this example, each selectable item 344 is an actionable button which, if activated, causes a corresponding suggested search query keyword to be added to the current search query 346A “chromebook” displayed in search query field 348 of UI340A.

Each selectable item 344 indicates that the suggested search query keyword that would be added to the current search query 346A if selected. For example, selectable item 344A indicates that the suggested search query keyword “11.6” would be added to current search query 346A if selected.

Each suggested search query keyword is determined based on the search result of the selected search result summary 110B selected by touch gesture 118. Techniques for determining suggested search query keywords based on a search result are described elsewhere in this description.

Also as shown in FIG. 3A, touch gesture 350 is performed to select selectable item 344A. In this example, touch gesture 350 is a tap, a press, or double tap touch gesture, but could just as easily be another type of touch gesture.

In response to touch gesture 350, the search query keyword “11.6” is added to current search query 346A to produce a new current search query 346B as shown in UI 340B of FIG. 3B. The user can submit the new current search query 346B to the search engine by activating search button 352 with appropriate user input. Appropriate user input may include, for example, a tap, press, or double-tap touch gesture directed to button 352.

In some embodiments, selecting selectable item 344A again after selecting selectable item 344A to add the search query keyword “11.6” to the current search query removes suggested search query keyword “11.6” from current search query 346B to return the current search query displayed in search field 348 to just “chromebook”.

The user can select one or more of the other selectable items 344B, 344C, and 344D to add the other suggested search query keywords to the current search query displayed in the search field 348.

### A Process for Type Free Search Assist

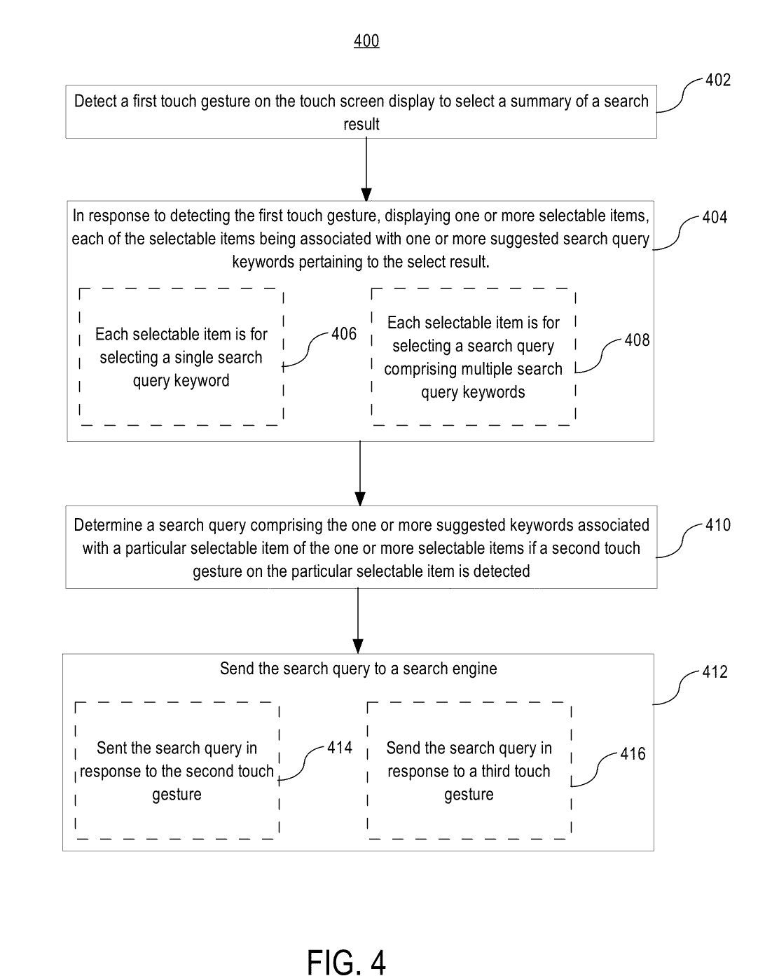

FIG. 4 is a flowchart of a process 400 for type free search assist according to some embodiments of the present invention. In some embodiments as described below, some steps of process 400 are performed by a portable computing device with a touch screen display such as device 500 of FIG. 5. Other steps or portions of steps, which may or may not be indicated in the flowchart, are performed by one or more computing devices of a search engine. The search engine may be, for example, an Internet search engine.

At block 402, the portable computing device detects a first touch gesture on the touch screen display of the portable computing device to select a summary of a search result. For example, the first touch gesture may be a drag, swipe, or flick touch gesture directed to an area of the touch screen display where the search result summary is displayed. The search result summary may be displayed as part of a search result document displayed on the touch screen display. The search result summary may be provided to the portable computing device by the search engine in response to the search engine identifying the search result as relevant to a first search query having one or more search query keywords

At block 404, one or more selectable items are displayed on the touch screen display in response to detecting the first touch gesture. Each of the one or more selectable items may be associated with one or more suggested search query keywords.

The suggested search query keywords may be determined by the search engine. The search engine may determine the suggested search query keywords in response to the first touch gesture. For example, in response to detecting the first touch gesture, the portable computing device may send a request to the search engine in which the search result summary or the search result selected by the first touch gesture is identified. In response, the search engine may return suggested search query keywords pertaining to the search result to the portable computing device. Alternatively, the search engine may determine suggested search query keywords for each search result summary returned in response to the first search query. In other words, the suggested search query keywords may be determined by the search engine before the first touch gesture is performed. In this case, the suggested search query keywords may be provided by the search engine as metadata to the search result summaries of the search results identified by the search result as relevant of the first search query.

The search engine may determine suggested search query keywords for a search result based on information that the search engine maintains for the search result for various purposes. Such various purposes may include information retrieval, indexing and logging, for example.

In some embodiments, the search engine determines suggested search query keywords for a search result from keywords the search engine considers to be especially important to the search result. Such keywords may be numerical scored by the search engine according to a relevance metric that reflects how important the keywords are to the search result in a corpus of search results. For example, the keywords may be scored according to a term frequency/inverse document frequency (TF/IDF) metric or a metric based thereon (e.g., Okapi BM25). When selecting suggested search query keywords for a search result, the search engine may select the top-n scoring keywords for the search result according to a relevance metric or relevance metrics.

In some embodiments, the search engine determines suggested search query keywords for a search result from keywords used in previous search queries for which the search engine identified the search result as relevant enough to be returned as a search result. Such keywords may be available from query logs that the search engine maintains.

In some embodiments, the search engine determines suggested search query keywords for a search result from a combination of relevant keywords and query keywords.

In some embodiments, the search engine determines a set of candidate suggested search query keywords for a search result and selects a subset of candidate set according to a diversity metric with the aim of selecting a suggested search query keywords for the search engine that have a degree of a keyword diversity. For example, the diversity metric may be an edit distance metric (e.g., the Levenshtein distance).

Overall, the suggested search query keywords associated with the selectable item displayed at block 404 may be determined by the search engine based on the search result that the user selected with the touch gesture detected in block 402. By doing so, the user can view the search result summaries that are returned by the search engine in response to the first search query, select one of the search result summaries for which to receive suggested search query keywords, and upon selecting a search result summary, receive selectable suggested search query keywords that are determined based on the search result selected by the user.

In some embodiments, each selectable item displayed at block 404 is for a single search query keyword as represented by sub-block 406. For example, each selectable item displayed at block 404 may be an actionable button user interface element like selectable items 344 of UI 340A as shown in FIG. 3A.

In some embodiments, each selectable item displayed at block 404 is for a single search query having multiple search query keywords as represented by sub-block 408. For example, each selectable item displayed at block 404 may be actionable hyperlink user interface element like selectable items 122 of UI 104B as shown in FIG. 1C.

At block 410, the portable computing device determines a search query having the one or more suggested search query keywords associated with a particular selectable item if a second touch gesture on the particular selectable item is detected. The second touch gesture may be a tap, press, or double-tap touch gesture in accordance with the first type free search assist technique, a right-to-left or left-to-right drag, swipe, or flick gesture in accordance with the progressive search result peeking technique, or a tap, press, or double-tap touch gesture in accordance with the second type free search assist technique. In some cases in accordance with the second type free search assist technique, the second touch gesture is repeated by the user to make multiple suggested keywords selections.

Determining the search query may involve combining the one or more search query keywords of the first search query with the one or more suggested search query keywords associated with the particular selectable item. For example, in accordance with the second type free search assist technique, determining the search query may involve concatenating the one or more suggested search query keywords associated with the particular selectable item to the one or more search query keywords of the first search query.

Determining the search query may instead involve determining a search query associated with the particular selectable item. The associated search query may have the one or more suggested search query keywords. The one or more suggested search query keywords may include the one or more search query keywords of the first search query.

At block 412, the portable computing device sends the search query determined at block 410 to the search engine. For example, the portable computing device may send the send query in a network request (e.g., a HyperText Transfer Protocol (HTTP) request or a Secure-HyperText Transfer Protocol (HTTPS) request).

As represented by sub-block 414, the portable computing device may send the search query to the search engine in response to second touch gesture. For example, the portable computing device may send the search query determined at block 410 in response to touch gesture 124 of FIG. 1C or in response to touch gesture 228 of FIG. 2A.

As representing by sub-block 416, the portable computing device may send the search query to the search engine in response to a third touch gesture. For example, the portable computing device may send the search query determined at block 410 in response to a tap, press, or double-tap touch gesture to activate button 352 of UI 340B as shown in FIG. 3C.

### Example Portable Computing Device

In some embodiments, the techniques described herein are implemented by a portable computing device with a touch screen display. For example, the device may be a mobile a smartphone, a tablet computer, or other portable computing device with a touch screen display.

The device may include one or more general purpose hardware processors programmed to perform the techniques pursuant to program instructions in firmware, memory, other storage, or a combination.

However, the specific nature of the devices through which the techniques are implemented may vary from implementation to implementation, and the techniques are not limited to any particular type of device or technology. For example, the techniques may be used to assist a user in formulating a search query using any device with a touch sensitive surface. The touch sensitive surface may overlay a display screen to form a touch screen display or be separate from the display screen. For example, the touch sensitive surface can be a touchpad or other separate touch sensitive surface. More generally, the techniques described herein are not necessarily implemented on currently-dominant forms of a computer, may also be implemented on other forms of computing and communication (past and future).

Rather than exclusively using general purpose hardware, a special-purpose computing device that implements the techniques described herein may be hard-wired to perform the techniques, or may include digital electronic devices such as one or more application-specific integrated circuits (ASICs) or field programmable gate arrays (FPGAs) that are persistently programmed to perform the techniques. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

Attention is now directed to embodiments of a portable computing device. FIG. 5 is a block diagram illustrating a portable computing device 500 with a touch-sensitive display 512 in accordance with some embodiments. The touch-sensitive display 512 is sometimes called a “touch screen” for convenience. The device 500 may include a memory 502 (which may include one or more non-transitory computer-readable media), a memory controller 522, one or more processing units (CPUs) 520, a peripherals interface 518, RF circuitry 508, audio circuitry 511, a microphone 513, an input/output (I/O) subsystem 506, other input or control devices 516, and an external port 524. The device 500 may include one or more optical sensors 564. These components may communicate over one or more communication busses or signal lines 503.

It should be appreciated that the device 500 is only one example of a portable computing device 500, and that the device 500 may have more or fewer components than shown, may combine two or more components, or a may have a different configuration or arrangement of the components. The various components shown in FIG. 5 may be implemented in hardware, software or a combination of both hardware and software, including one or more signal processing and/or application specific integrated circuits.

Memory 502 may include high-speed random access memory and may also include non-volatile memory, such as one or more magnetic disk storage devices, flash memory devices, or other non-volatile solid-state memory devices. Access to memory 502 by other components of the device 500, such as the CPU 520 and the peripherals interface 518, may be controlled by the memory controller 522.

The peripherals interface 518 couples the input and output peripherals of the device to the CPU 520 and memory 502. The one or more processors 520 run or execute various software programs and/or sets of instructions stored in memory 502 to perform various functions for the device 500 and to process data.

In some embodiments, the peripherals interface 518, the CPU 520, and the memory controller 522 may be implemented on a single chip, such as a chip 504. In some other embodiments, they may be implemented on separate chips.

The RF (radio frequency) circuitry 508 receives and sends RF signals, also called electromagnetic signals. The RF circuitry 508 converts electrical signals to/from electromagnetic signals and communicates with communications networks and other communications devices via the electromagnetic signals. The RF circuitry 508 may include well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. The RF circuitry 508 may communicate with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The wireless communication may use any of a plurality of communications standards, protocols and technologies, including but not limited to Global System for Mobile Communications (GSM), Enhanced Data GSM Environment (EDGE), wideband code division multiple access (W-CDMA), code division multiple access (CDMA), time division multiple access (TDMA), Bluetooth, Wireless Fidelity (Wi-Fi) (e.g., IEEE 802.11a, IEEE 802.11b, IEEE 802.11g and/or IEEE 802.11n), voice over Internet Protocol (VoIP), Wi-MAX, a protocol for email, instant messaging, and/or Short Message Service (SMS)), or any other suitable communication protocol, including communication protocols developed in the past or not yet developed as of the filing date of this document.

The audio circuitry 510, the speaker 511, and the microphone 513 provide an audio interface between a user and the device 500. The audio circuitry 510 receives audio data from the peripherals interface 518, converts the audio data to an electrical signal, and transmits the electrical signal to the speaker 511. The speaker 511 converts the electrical signal to human-audible sound waves. The audio circuitry 510 also receives electrical signals converted by the microphone 513 from sound waves. The audio circuitry 510 converts the electrical signal to audio data and transmits the audio data to the peripherals interface 518 for processing. Audio data may be retrieved from and/or transmitted to memory 502 and/or the RF circuitry 508 by the peripherals interface 518. In some embodiments, the audio circuitry 510 also includes a headset jack (not shown). The headset jack provides an interface between the audio circuitry 510 and removable audio input/output peripherals, such as output-only headphones or a headset with both output (e.g., a headphone for one or both ears) and input (e.g., a microphone).

The I/O subsystem 506 couples input/output peripherals on the device 500, such as the touch screen 512 and other input/control devices 516, to the peripherals interface 518. The I/O subsystem 506 may include a display controller 556 and one or more input controllers 560 for other input or control devices. The one or more input controllers 560 receive/send electrical signals from/to other input or control devices 516. The other input/control devices 516 may include physical buttons (e.g., push buttons, rocker buttons, etc.), dials, slider switches, joysticks, click wheels, and so forth. In some alternate embodiments, input controller(s) 560 may be coupled to any (or none) of the following: a keyboard, infrared port, USB port, and a pointer device such as a mouse. The one or more buttons may include an up/down button for volume control of the speaker 511 and/or the microphone 513. The one or more buttons may include a push button. A quick press of the push button may disengage a lock of the touch screen 512 or begin a process that uses gestures on the touch screen to unlock the device. A longer press of the push button may turn power to the device 500 on or off. The user may be able to customize a functionality of one or more of the buttons. The touch screen 512 is used to implement virtual or soft buttons and one or more soft keyboards.

The touch-sensitive touch screen 512 provides an input interface and an output interface between the device and a user. The display controller 556 receives and/or sends electrical signals from/to the touch screen 512. The touch screen 512 displays visual output to the user. The visual output may include graphics, text, icons, video, and any combination thereof (collectively termed “graphics”). In some embodiments, some or all of the visual output may correspond to user-interface objects, further details of which are described below.

A touch screen 512 has a touch-sensitive surface, sensor or set of sensors that accepts input from the user based on haptic and/or tactile contact. The touch screen 512 and the display controller 556 (along with any associated modules and/or sets of instructions in memory 502) detect contact (and any movement or breaking of the contact) on the touch screen 512 and converts the detected contact into interaction with user-interface objects (e.g., one or more soft keys, icons, web pages or images) that are displayed on the touch screen. In an exemplary embodiment, a point of contact between a touch screen 512 and the user corresponds to a finger of the user.

The touch screen 512 may use LCD (liquid crystal display) technology, or LPD (light emitting polymer display) technology, although other display technologies may be used in other embodiments. The touch screen 512 and the display controller 556 may detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with a touch screen 512.

The user may make contact with the touch screen 512 using any suitable object or appendage, such as a stylus, a finger, and so forth. In some embodiments, the user interface is designed to work primarily with finger-based contacts and gestures, which are much less precise than stylus-based input due to the larger area of contact of a finger on the touch screen. In some embodiments, the device translates the rough finger-based input into a precise pointer/cursor position or command for performing the actions desired by the user.

In some embodiments, in addition to the touch screen, the device 500 may include a touchpad (not shown) for activating or deactivating particular functions. In some embodiments, the touchpad is a touch-sensitive area of the device that, unlike the touch screen, does not display visual output. The touchpad may be a touch-sensitive surface that is separate from the touch screen 512 or an extension of the touch-sensitive surface formed by the touch screen.

In some embodiments, the device 500 may include a physical or virtual click wheel as an input control device 516. A user may navigate among and interact with one or more graphical objects (henceforth referred to as icons) displayed in the touch screen 512 by rotating the click wheel or by moving a point of contact with the click wheel (e.g., where the amount of movement of the point of contact is measured by its angular displacement with respect to a center point of the click wheel). The click wheel may also be used to select one or more of the displayed icons. For example, the user may press down on at least a portion of the click wheel or an associated button. User commands and navigation commands provided by the user via the click wheel may be processed by an input controller 560 as well as one or more of the modules and/or sets of instructions in memory 502. For a virtual click wheel, the click wheel and click wheel controller may be part of the touch screen 512 and the display controller 556, respectively. For a virtual click wheel, the click wheel may be either an opaque or semitransparent object that appears and disappears on the touch screen display in response to user interaction with the device. In some embodiments, a virtual click wheel is displayed on the touch screen of a portable multifunction device and operated by user contact with the touch screen.

The device 500 also includes a power system 562 for powering the various components. The power system 562 may include a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable electronic devices.

The device 500 may also include one or more optical sensors 564. FIG. 5 shows an optical sensor coupled to an optical sensor controller 558 in I/O subsystem 506. The optical sensor 564 may include charge-coupled device (CCD) or complementary metal-oxide semiconductor (CMOS) phototransistors. The optical sensor 564 receives light from the environment, projected through one or more lens, and converts the light to data representing an image. In conjunction with an imaging module, the optical sensor 564 may capture still images or video. In some embodiments, an optical sensor is located on the back of the device 500, opposite the touch screen display 512 on the front of the device 500, so that the touch screen display may be used as a viewfinder for either still and/or video image acquisition. In some embodiments, an optical sensor is located on the front of the device so that the user's image may be obtained for videoconferencing while the user views the other video conference participants on the touch screen display. In some embodiments, the position of the optical sensor 564 can be changed by the user (e.g., by rotating the lens and the sensor in the device housing) so that a single optical sensor 564 may be used along with the touch screen display for both video conferencing and still and/or video image acquisition.

The device 500 may also include one or more proximity sensors 566. FIG. 5 shows a proximity sensor 566 coupled to the peripherals interface 518. Alternately, the proximity sensor 566 may be coupled to an input controller 560 in the I/O subsystem 506. In some embodiments, the proximity sensor turns off and disables the touch screen 512 when the multifunction device is placed near the user's ear (e.g., when the user is making a phone call). In some embodiments, the proximity sensor keeps the screen off when the device is in the user's pocket, purse, or other dark area to prevent unnecessary battery drainage when the device is a locked state.

In some embodiments, the software components stored in memory 502 may include an operating system 526, a communication module (or set of instructions) 527, a contact/motion module (or set of instructions) 528, a graphics module (or set of instructions) 529, a text input module (or set of instructions) 530, and a type free search assist module (or set of instructions) 531. Although shown separately in memory 502 of FIG. 5, one or more of communication module 527, contact/motion module 528, graphics module 529, text input module 530, or type free search assist module 531 may be a component of operating system 526.

The operating system 526 (e.g., ANDROID, IOS, UNIX, OS X, or WINDOWS) includes various software components and/or drivers for controlling and managing general system tasks (e.g., memory management, storage device control, power management, etc.) and facilitates communication between various hardware and software components.

The communication module 527 facilitates communication with other devices over one or more external ports 524 and also includes various software components for handling data received by the RF circuitry 508 and/or the external port 524. The external port 524 (e.g., Universal Serial Bus (USB), FIREWIRE, etc.) is adapted for coupling directly to other devices or indirectly over a network (e.g., the Internet, wireless LAN, etc.).

The contact/motion module 528 may detect contact with the touch screen 512 (in conjunction with the display controller 556) and other touch sensitive devices (e.g., a touchpad or physical click wheel). The contact/motion module 528 includes various software components for performing various operations related to detection of contact, such as determining if contact has occurred, determining if there is movement of the contact and tracking the movement across the touch screen 512, and determining if the contact has been broken (i.e., if the contact has ceased). Determining movement of the point of contact may include determining speed (magnitude), velocity (magnitude and direction), and/or an acceleration (a change in magnitude and/or direction) of the point of contact. These operations may be applied to single contacts (e.g., one finger contacts) or to multiple simultaneous contacts (e.g., “multitouch”/multiple finger contacts). In some embodiments, the contact/motion module 528 and the display controller 556 also detects contact on a touchpad. In some embodiments, the contact/motion module 528 and the controller 560 detects contact on a click wheel 516.

The graphics module 529 includes various known software components for rendering and displaying graphics on the touch screen 512, including components for changing the intensity of graphics that are displayed. As used herein, the term “graphics” includes any object that can be displayed to a user, including without limitation text, web pages, icons (such as user-interface objects including soft keys), digital images, videos, animations and the like. An animation in this context is a display of a sequence of images that gives the appearance of movement, and informs the user of an action that has been performed (such as moving an email message to a folder). In this context, a respective animation that confirms an action by the user of the device typically takes a predefined, finite amount of time, typically between 0.2 and 1.0 seconds, and generally less than two seconds.

The text input module 530, which may be a component of graphics module 529, provides soft keyboards for entering text in various applications (e.g., a contacts application, an e-mail application, an instant messaging application, a blogging application, a web browser application, and any other application that needs text input).

Type free search assist module 531 may be used to assist a user of device 500 in formulating a search query without requiring the user to individually enter the letters of search query keywords using a keyboard. Type free search assist module 531 may be a stand-alone module or a sub-module of another module. In some embodiments, type free search assist module 531 is implemented by web browser executable instructions. For example, such web browser executable instructions may include one or more of HTML (Hypertext Markup Language) instructions, CSS (Cascading Style Sheets) instructions, JavaScript instructions, or other instructions executable by a web browser. The web browser (e.g., SAFARI, OPERA, CHROME, EXPLORER, or MOZILLA) may be a stand-alone web browsing application stored in memory 502 and executing on device 500, a sub-component of another application stored in memory 502 and executing on device 500, or invoked as library (e.g., as a DLL (dynamic link library) stored in memory 502 by another application stored in memory 502 and executing on device 500.

### Extensions, Alternatives, and Terminology

In the foregoing description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

Some portions of the above description relate to providing suggested search query keywords in response to a user selecting a search result summary. In other embodiments, suggested search query keywords are provided in response to a user selecting information other than a search result summary. For example, the other information may be a paragraph or sentence of an online article, a blog post, or web page. As another example, the other information may be a user comment entry in a threaded comments section of a web page.

It will also be understood that, although the terms first, second, etc. may be used herein to describe various elements, these elements should not be limited by these terms. These terms are only used to distinguish one element from another. For example, a figure gesture could be termed a second gesture, and, similarly, a second gesture could be termed a first gesture, without departing from the scope of the present invention.

As used in the description of the invention and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

1. A method comprising:
at a portable computing device with a display:
detecting first user input to select a summary of a search result displayed on the display;
in response to detecting the first user input, displaying one or more selectable items on the display, each selectable item of the one or more selectable items associated with one or more suggested search query keywords pertaining to the search result;
determining a search query comprising the one or more suggested keywords associated with a particular selectable item of the one or more selectable items if a second user input to select the particular selectable item is detected; and
sending the search query to a search engine.

2. The method of claim 1, wherein each selectable item of the one or more selectable items is displayed as an actionable hyperlink.

3. The method of claim 1, wherein each selectable item of the one or more selectable items is associated with a plurality of suggested search query keywords pertaining to the search result.

4. The method of claim 1, where each selectable item of the one or more selectable items is associated with one suggested search query keyword pertaining to the search result.

5. The method of claim 1, wherein each selectable item of the one or more selectable items is displayed as an actionable button.

6. The method of claim 1, wherein each selectable item of the one or more selectable items displays the one or more suggested search query keywords associated with the selectable item.

7. The method of claim 1, wherein the display is a touch screen display; and wherein the first user input is a touch gesture.

8. The method of claim 7, wherein the touch gesture is a drag, swipe, or flick touch gesture directed to an area of the touch screen display where the summary of the search result is displayed.

9. The method of claim 1, wherein the display is a touch screen display; and wherein the second user input is a touch gesture.

10. The method of claim 9, wherein the touch gesture is a tap, press, or double-tap touch gesture directed to an of the touch screen display where the particular selectable item is displayed.

11. The method of claim 9, wherein the touch gesture is a drag, swipe, or flick touch gesture directed to an of the touch screen display where the particular selectable item is displayed.

12. The method of claim 1, wherein the device has a touch pad; and wherein the first user input is a touch gesture.

13. The method of claim 12, wherein the touch gesture is a drag, swipe, or flick touch gesture directed to the touch pad to select the summary of the search result.

14. The method of claim 1, wherein the device has a touch pad; and wherein the second user input is a touch gesture.

15. The method of claim 14, wherein the touch gesture is a tap, press, or double-tap touch gesture directed to the touch pad to select the particular selectable item.

16. The method of claim 14, wherein the touch gesture is a drag, swipe, or flick touch gesture directed to the touch pad to select the particular selectable item.

17. The method of claim 1, wherein the device has an optical sensor for tracking user eyeball movement; and wherein detecting the first user input comprises detecting movement of a user's eyeball based at least in part on information provided by the optical sensor.

18. The method of claim 1, further comprising:
in response to sending the search query to the search engine, receiving from the search engine at least one search result summary pertaining to the search query; and
displaying the at least one search result summary on the touch screen display.

19. The method of claim 1, further comprising:
sending the search query to the search engine in response to detecting the second touch gesture.

20. A method comprising:
at a computing device with a touch screen display:
detecting a first touch gesture on the touch screen display to select a summary of a search result displayed on the touch screen display;
in response to detecting the first touch gesture, displaying one or more selectable items on a selectable item panel, each selectable item of the one or more selectable items associated with one or more suggested search query keywords pertaining to the search result;
determining a search query comprising the one or more suggested keywords associated with a particular selectable item of the one or more selectable items if a second touch gesture on the selectable item panel is detected; and
sending the search query to a search engine.

21. The method of claim 11, further comprising:
in response to sending the search query to the search engine, receiving from the search engine at least one search result summary pertaining to the search query; and
displaying the at least one search result summary on the touch screen display.

22. The method of claim 11, wherein the second touch gesture is a drag, swipe, or flick touch gesture directed to an area of the touch screen display where the selectable item panel is displayed.

23. A computing device with a touch screen display, the computing device having a type free search assist mechanism configured to:
detect a first touch gesture on the touch screen display to select a summary of a search result displayed on the touch screen display;
displaying one or more selectable items in response to detecting the first touch gesture;
wherein each selectable item of the one or more selectable items is associated with one or more suggested search query keywords pertaining to the search result;
determine a search query comprising the one or more suggested keywords associated with a particular selectable item of the one or more selectable items if a second touch gesture on the particular selectable item is detected; and
send the search query to a search engine.

24. The device of claim 23, wherein the summary of the search result comprises a title, an abstract, and a Uniform Resource Locator (URL).

25. The device of claim 23, wherein the summary of the search result is displayed as part of a search result document also displayed on the touch screen display.

26. The device of claim 23, wherein the summary of the search result is provided by the search engine before the first touch gesture is detected.

27. One or more non-transitory computer readable media storing instructions which, when served to and executed by a portable computing device with a touch screen display, causes the portable computing device to perform a method comprising:
detecting a first touch gesture on the touch screen display to select a summary of a search result displayed on the touch screen display;
in response to detecting the first touch gesture, displaying one or more selectable items, each selectable item of the one or more selectable items associated with one or more suggested search query keywords pertaining to the search result;
determining a search query comprising the one or more suggested keywords associated with a particular selectable item of the one or more selectable items if a second touch gesture on the particular selectable item is detected; and
sending the search query to a search engine.

28. The method of claim 27, wherein determining the search query comprises:
determining an initial search query that produced the summary of the search result; and
combining the initial search query with the one or more suggested keywords associated with the particular selectable item to produce the search query.

29. The method of claim 27, further comprising:
detecting a third touch gesture on the touch screen display to send the search query to the search engine; and
sending the search query to the search engine in response to detecting the third touch gesture.
